(19) United States
(12) Patent Application Publication
(10) Pub. No.: US 2022/0304000 A1
(43) Pub. Date: Sep. 22, 2022

(54) TRANSMISSION RATE CONFIGURATION METHOD AND APPARATUS

(71) Applicant: HUAWEI TECHNOLOGIES CO., LTD., Shenzhen (CN)

(72) Inventors: Yiming WANG, Dongguan (CN); Yun ZHOU, Wuhan (CN); Gang GAI, Shenzhen (CN)

(73) Assignee: HUAWEI TECHNOLOGIES CO., LTD., Shenzhen (CN)

(21) Appl. No.: 17/837,342

(22) Filed: Jun. 10, 2022

Related U.S. Application Data
(63) Continuation of application No. PCT/CN2020/116630, filed on Sep. 21, 2020.

(30) Foreign Application Priority Data
Dec. 11, 2019 (CN) 201911267103.3

(51) Int. Cl. H04W 72/08; H04W 28/02; H04L 47/22

(52) U.S. Cl. CPC H04W 72/087; H04W 28/0257; H04W 28/0268; H04L 47/225; H04L 1/0003

(57) ABSTRACT

A transmission rate configuration method and an apparatus. An access point determines a service type of a service to which a data stream belongs and configures a transmission rate of the data stream based on the service type. The configured transmission rate meets a requirement of the service to which the data stream belongs, thereby improving flexibility of a transmission rate configuration process, so that a downlink data transmission process meets transmission requirements of different services.

### CROSS-REFERENCE TO RELATED APPLICATIONS

This application is a continuation of International Application No. PCT/CN2020/116630, filed on Sep. 21, 2020, which claims priority to Chinese Patent Application No. 201911267103.3, filed on Dec. 11, 2019. The disclosures of the aforementioned applications are hereby incorporated by reference in their entireties.

### TECHNICAL FIELD

The embodiments relate to the field of communication technologies, and a transmission rate configuration method and an apparatus.

### BACKGROUND

In current wireless fidelity (WIFI) network communication, a WIFI signal may be provided by an access point (AP, for example, an access hotspot), for accessing the Internet by a terminal device (or may be referred to as a station (STA)) that has a WIFI communication function, such as a mobile phone or a tablet computer.

Currently, when determining a transmission rate of a data stream, a gateway device is not concerned about a service type of a service to which the data stream belongs, for example, chooses to configure transmission rates for data streams of different services in a throughput maximizing manner. The transmission rate is used to guarantee that the data stream can obtain a data transmission guarantee during transmission, for example, obtain guarantees in terms of a latency, bandwidth, and a packet loss rate (PLR).

However, with continuous extension of a service type, a throughput is no longer an only concerned indicator in a service data transmission process. Therefore, if a transmission rate is configured based on a throughput or another single principle, data transmission guarantee requirements of different services cannot be met. Therefore, an existing transmission rate configuration manner of the gateway device needs to be improved.

### SUMMARY

A transmission rate configuration method and an apparatus may improve flexibility of downlink transmission rate configuration of an access point, so that a downlink data transmission process meets requirements of different services.

According to a first aspect, a transmission rate configuration method may be performed by an access point or a chip in the access point. The access point is configured to provide a WIFI signal. A form of the access point may be a device that can provide a WIFI signal, such as an access hotspot, customer premises equipment (CPE), or a gateway.

According to the method, the access point may determine a service type of a service to which a data stream belongs and configure a transmission rate of the data stream based on the service type.

In the foregoing method, the access point may configure, based on a service characteristic of the data stream, the transmission rate used when the data stream is sent. Therefore, the configured transmission rate meets a requirement of the service to which the data stream belongs, thereby improving flexibility of a transmission rate configuration process, so that a downlink data transmission process meets transmission requirements of different services.

In a possible example, when the service type is used to indicate that the service to which the data stream belongs is a first-type service, the access point may configure the transmission rate of the data stream as a first transmission rate. The first transmission rate is not greater than a first rate threshold. A transmission latency required by the first-type service is not higher than a latency threshold.

In this method, when the service to which the data stream belongs is the first-type service that has a relatively high transmission latency requirement, a relatively small transmission rate may be configured for the data stream, so that a packet loss rate in a data transmission process is reduced by reducing a sending rate, to reduce a transmission latency. The first-type service is a real-time online service such as multiplayer online battle arena (MOBA), Player Unknown's Battlegrounds, or red packet grabbing.

In another possible example, when the service type is used to indicate that the service to which the data stream belongs is a download service, such as a hypertext transfer protocol (HTTP) download service, the access point may configure the transmission rate of the data stream as the second transmission rate. The second transmission rate is not less than a second rate threshold.

In this method, for a data stream of the HTTP download service, the access point may reduce a packet loss rate in downlink transmission by using a relatively high transmission rate, so that packet retransmissions are reduced by reducing packet losses, to obtain stable high-rate download experience.

In addition, the access point may alternatively configure the transmission rate of the data stream based on the service type of the data stream and traffic information of the data stream.

In this method, the access point determines the transmission rate of the data stream by considering the service type of the data stream and the traffic information of the data stream, thereby further improving flexibility of data stream transmission rate configuration.

In a possible example, when the service type indicates that the service to which the data stream belongs is a second-type service, and the traffic information indicates that a traffic peak value of the data stream is not lower than n times of average traffic of the data stream, the access point may configure the transmission rate of the data stream to be not less than x times of the average traffic of the data stream, where x is greater than 1. A packet loss rate required by the second-type service is not higher than a packet loss rate threshold, and n is greater than 1. For example, x is greater than n.

In this method, for a service that requires a relatively high packet loss rate and has a relatively severe traffic burst in a data stream, the access point may configure a transmission rate of the data stream based on average traffic of the data stream, so that the transmission rate is not lower than x times of the average traffic (x is greater than 1), to provide a stable air interface transmission rate for the service, thereby avoiding a packet loss caused by a transmission rate selection change due to air interface fluctuation, improving an anti-interference capability in downlink data transmission, and guaranteeing good experience of the service.

In this example, the access point may further perform traffic shaping on the data stream, so that traffic fluctuation is smoother after the shaping, to reduce a traffic burst occurrence probability. Therefore, an anti-interference capability in downlink data transmission can be further improved.

In another example, the access point may further obtain a communication status parameter of the access point and a receive end. The receive end is configured to receive the data stream. The access point may configure the transmission rate of the data stream based on the service type of the service to which the data stream belongs and the communication status parameter, or the access point may configure the transmission rate of the data stream based on the service type of the service to which the data stream belongs, a traffic model of the data stream, and the communication status parameter.

In this method, the access point determines the transmission rate of the data stream by considering the service type of the data stream, the traffic information of the data stream, and/or the communication status parameter of the access point and the receive end, thereby further improving flexibility of data stream transmission rate configuration.

The communication status parameter includes a part or all of the following parameters: an air interface bit error rate; an air interface retransmission rate; or an air interface rate of the receive end.

It should be understood that, when configuring the transmission rate of the data stream, the access point may determine a transmission rate parameter of the data stream based on the service type. The transmission rate parameter of the data stream includes a part or all of the following parameters: a modulation and coding scheme (MCS) rate; an aggregation degree of an aggregate media access control (MAC) service data unit ((A-MSDU); an aggregation degree of an aggregate MAC protocol data unit (MPDU) (A-MPDU); or a queue allocation rule of Wi-Fi multimedia (WMM).

According to a second aspect, a communications apparatus may be an access point or a chip in the access point. The communications apparatus may be configured to perform the function, the step, or the operation provided in any one of the first aspect or the possible designs of the first aspect. The communications apparatus may implement functions, the steps, or the operations in the foregoing methods in a form of a hardware structure, a software module, or a combination of the hardware structure and the software module. For example, function modules corresponding to the functions, the steps, or the operations in the foregoing methods may be disposed in the communications apparatus, to support the communications apparatus in performing the foregoing methods.

When the communications apparatus in the second aspect is implemented by using a software module, the communications apparatus may include a communications module and a processing module that are coupled to each other. The communications module may be configured to support the communications apparatus in performing communication and configuring a parameter required for communication. The processing module may be used by the communications apparatus to perform a processing operation, for example, generate information/a message that needs to be sent by using the communications module, or process a signal received by the communications module, to obtain information/a message.

For example, the processing module may be configured to determine a service type of a service to which a data stream belongs. The communications module may be configured to configure a transmission rate of the data stream based on the service type.

In addition, the communications module may be further configured to send the data stream based on the configured transmission rate.

In a possible example, when the service type is used to indicate that the service to which the data stream belongs is a first-type service, the communications module may configure the transmission rate of the data stream as a first transmission rate. The first transmission rate is not greater than a first rate threshold. A transmission latency required by the first-type service is not higher than a latency threshold.

In another possible example, when the service type is used to indicate that the service to which the data stream belongs is an HTTP download service, the communications module may configure the transmission rate of the data stream as a second transmission rate. The second transmission rate is not less than a second rate threshold.

In another example, the communications module may alternatively configure the transmission rate of the data stream based on the service type and traffic information of the data stream.

When the service type is used to indicate that the service to which the data stream belongs is a second-type service, and the traffic information is used to indicate that a traffic peak value of the data stream is not lower than n times of average traffic of the data stream, the communications module may configure the transmission rate of the data stream to be not less than x times of the average traffic of the data stream, where x is greater than 1. A packet loss rate required by the second-type service is not higher than a packet loss rate threshold, and n is greater than 1. For example, x is greater than n.

In this example, the processing module may further perform traffic shaping on the data stream, so that traffic fluctuation is smoother after the shaping, to reduce a traffic burst occurrence probability. Therefore, an anti-interference capability in downlink data transmission can be further improved.

In another example, the communications module may further obtain a communication status parameter of the access point and a receive end. The receive end is configured to receive the data stream. The communications module may configure the transmission rate of the data stream based on the service type of the service to which the data stream belongs and the communication status parameter, or the communications module may configure the transmission rate of the data stream based on the service type of the service to which the data stream belongs, a traffic model of the data stream, and the communication status parameter.

In this method, the communications module determines the transmission rate of the data stream by considering the service type of the data stream, the traffic information of the data stream, and/or the communication status parameter of the access point and the receive end, thereby further improving flexibility of data stream transmission rate configuration.

The communication status parameter includes a part or all of the following parameters: an air interface bit error rate; an air interface retransmission rate; or an air interface rate of the receive end.

It should be understood that, when configuring the transmission rate of the data stream, the access point may determine a transmission rate parameter of the data stream based on the service type. The transmission rate parameter of the data stream includes a part or all of the following parameters: an MCS rate; an aggregation degree of an A-MSDU; an aggregation degree of an A-MPDU; or a queue allocation rule of WMM.

According to a third aspect, a computer-readable storage medium stores instructions (or referred to as a program). When the instructions are invoked and executed on a computer, the computer is enabled to perform the method according to any one of the first aspect or the possible designs of the first aspect.

According to a fourth aspect, a computer program product may include instructions. When the computer program product runs on a computer, the computer is enabled to perform the method according to any one of the first aspect or the possible designs of the first aspect.

According to a fifth aspect, a chip and/or a chip system including the chip may include a processor. The chip may further include a memory (or a storage module) and/or a transceiver (or a communications module). The chip may be configured to perform the method according to any one of the first aspect or the possible designs of the first aspect. The chip system may include the chip, or may include the chip and another discrete component, such as a memory (or a storage module) and/or a transceiver (or a communications module).

For beneficial effects of the second aspect to the fifth aspect and the possible designs of the second aspect to the fifth aspect, refer to descriptions of the beneficial effects of the method according to any one of the first aspect and the possible designs of the first aspect.

### BRIEF DESCRIPTION OF THE DRAWINGS

FIG. 1 is a schematic architectural diagram of a wireless communications system according to an embodiment;

FIG. 2 is a schematic architectural diagram of another wireless communications system according to an embodiment;

FIG. 3 is a schematic diagram of a structure of an access point according to an embodiment;

FIG. 4 is a schematic flowchart of a communication method according to an embodiment;

FIG. 5 is a schematic diagram of a traffic shaping effect according to an embodiment;

FIG. 6 is a schematic diagram of a channel selection effect according to an embodiment;

FIG. 7 is a schematic diagram of a structure of a channel apparatus according to an embodiment;

FIG. 8 is a schematic diagram of a structure of another channel apparatus according to an embodiment; and

FIG. 9 is a schematic diagram of a structure of another channel apparatus according to an embodiment.

### DETAILED DESCRIPTION OF THE EMBODIMENTS

To resolve a problem, in the conventional technology, that a transmission rate configuration process of an access point in a downlink data sending process is not flexible enough, a transmission rate configuration method may improve flexibility of downlink data transmission rate configuration, so that a downlink data transmission process meets transmission rate requirements of different services.

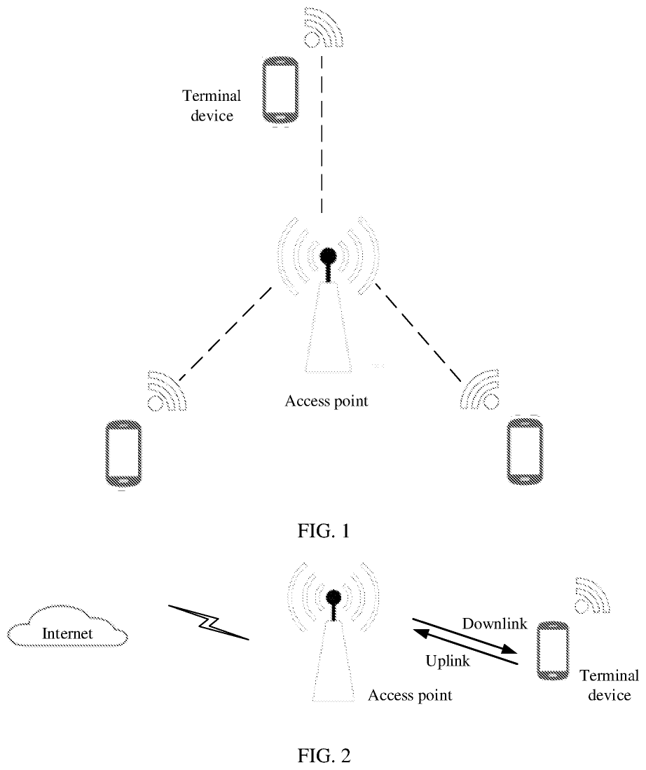

As shown in FIG. 1, the transmission rate configuration method provided in the embodiments may be used in a communications system including an access point and at least one terminal device. The access point may be configured to provide a WIFI signal. By using the access point, the terminal device in the communications system shown in FIG. 1 may communicate with a communications device outside the communications system shown in FIG. 1. For example, the terminal device may access the Internet by using the access point. In addition, a plurality of terminal devices shown in FIG. 1 may communicate with each other by using the access point.

For example, the access point may be a device that can provide a WIFI signal, such as an AP, customer premises equipment (CPE), or a gateway. The access point may be alternatively a device that can provide a WIFI hotspot, for example, a mobile terminal that can access a mobile network and provide a WIFI hotspot. For example, the access point may be implemented by a chip or a chip system.

The terminal device may include a mobile phone, a tablet computer, a wearable device (such as a smartwatch) having a wireless communication function, a vehicle-mounted device, or the like. An example embodiment of the terminal device includes but is not limited to an electronic device in which iOS®, Android®, Microsoft®, or another operating system is installed. The electronic device may alternatively be, for example, a laptop having a touch-sensitive surface (for example, a touch panel). It should be further understood that, in some other embodiments, the terminal device may be alternatively a device, such as a desktop computer that has a WIFI network access capability. For example, the terminal device may be a wireless terminal. For example, the terminal device may be implemented by a chip or a chip system.

It should be understood that the access point may be configured to provide a WIFI network (or referred to as a WIFI hotspot), and the terminal device may be configured to search for and access the WIFI network. It should be understood that there is no limitation that the terminal device can fall within a coverage area of a WIFI network provided by only one access point and there is no limitation that a coverage area of a WIFI network provided by the access point includes only one terminal device.

As shown in FIG. 2, a signal sent by an access point to a terminal device may be referred to as a downlink signal, and a downlink signal sending process may be referred to as downlink sending. The downlink signal may be used to carry signaling and/or data that are/is sent to the terminal device. The signaling may be referred to as downlink signaling, and the data may be referred to as downlink data. In addition, a signal sent by the terminal device to the access point may be referred to as an uplink signal. The uplink signal may be used to carry signaling and/or data that are/is sent by the terminal device. The signaling may be referred to as uplink signaling, and the data may be referred to as uplink data.

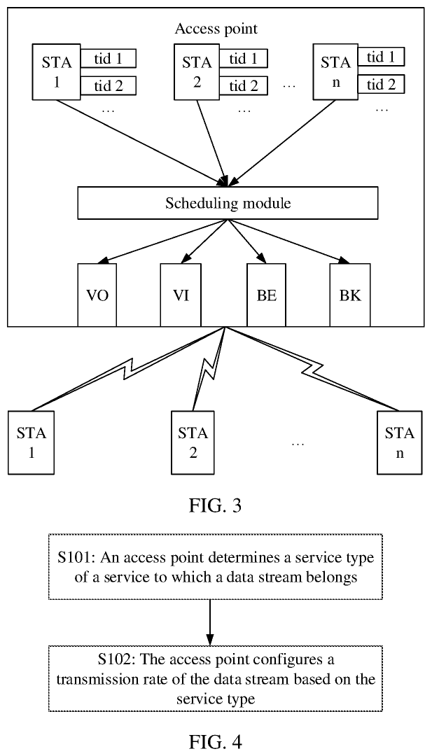

As shown in FIG. 3, when sending downlink data streams to a plurality of terminal devices (respectively marked as an STA 1, an STA 2, . . . , and STA n), an access point provided in this embodiment may allocate the data streams to different STA queues based on differentiated services code points (DSCP) of services to which the data streams belong. Each STA queue corresponds to a value of one DSCP. For example, different data streams may be represented by using traffic identifiers (tid), for example, a tid 1, a tid 2, . . . in FIG. 3.

In addition, the access point may place, by using a scheduling module (or scheduler), downlink data in a tid queue into a Wi-Fi multimedia (WMM) queue corresponding to the tid queue, for waiting for sending. For access category (AC) data streams, WMM queues are classified into four priority queues in ascending order of priorities: an AC-voice (AC-VO) stream, an AC-video (AC-VI) stream, an AC-best effort (AC-BE) stream, and an AC-background (AC-BK) stream, and it is guaranteed that a packet in a higher-priority queue has a higher channel preemption capability. The access point may further configure a transmission rate related to a downlink data sending process, for sending downlink data. The transmission rate is a parameter such as a modulation and coding scheme (MCS) rate configuration, a guard interval (GI), bandwidth (BW), the number of spatial streams (NSS), an aggregation degree of an aggregate media access control (MAC) service data unit (A-MSDU), an aggregation degree of an aggregate MAC protocol data unit (A-MPDU), or a number of times configuration in a scheduling or retransmission policy that is based on a service set identifier (SSID) and a terminal device. It should be understood that downlink transmission rate may be configured in of the access point.

As shown in FIG. 4, a transmission rate configuration method provided in an embodiment may include the following steps:

S101: An access point determines a service type of a service to which a data stream belongs.

The data stream may be a downlink data stream that is sent to the access point and that needs to be sent by the access point to a terminal device. The service type may be used to represent a type of the service to which the data stream belongs. For example, the service type may include a video service, an online game service, a download service, a virtual reality (VR) service, and/or a low-latency service.

S102: The access point configures a transmission rate of the data stream based on the service type of the service to which the data stream belongs. Accordingly, the access point can send the data stream to the terminal device based on the configured transmission rate.

In the foregoing method, the access point may configure, based on a service characteristic of the data stream, the transmission rate used when the data stream is sent. Therefore, the configured transmission rate meets a requirement of the service to which the data stream belongs, thereby improving flexibility of a transmission rate configuration process.

It should be understood that, the access point may configure the transmission rate of the data stream based on the service type of the service to which the data stream belongs, so that a data stream transmission process meets a transmission latency requirement, a throughput requirement, a packet loss rate requirement, and/or the like of the service to which the data stream belongs.

For example, the access point may identify, based on a packet of the data stream, the service type of the service to which the data stream belongs. For example, the access point may obtain a service identifier carried in the packet of the data stream, to determine the service to which the data stream belongs, to further determine the service type of the service. For another example, the packet of the data stream may carry a source IP address of the data stream, the source IP address is, for example, an address of a server that provides the service, and the access point may query the service type of the service based on the source IP address. In addition, the packet of the data stream may alternatively carry indication information of the service type, such as a service type identifier.

In addition, the access point may alternatively identify, based on a traffic model of the data stream, the service type of the service to which the data stream belongs. For example, distribution rules exist in terms of a peak value, a traffic average value, and a traffic fluctuation status of a data stream of a service type. The access point may compare a data stream from a network with distribution rules of a stored traffic model to determine whether the data stream is a data stream that has distribution rules; and when recognizing that these rules exist in the data stream, the access point can recognize that a service to which the data stream belongs to a service type.

In addition, it should be understood that the access point may alternatively determine, in another manner in the conventional technology, the service type of the service to which the data stream belongs.

For example, the transmission latency requirement, the throughput requirement, the packet loss rate requirement, and/or the like of the service type may be represented as a correspondence between the service type and the transmission latency requirement, the throughput requirement, the packet loss rate requirement, and/or the like. The service type and the service requirement may be preconfigured in the access point or may be obtained by the access point from the terminal device or a network side.

As shown in Table 1, the access point may store a correspondence between the service type and the service requirement of the service. After recognizing the service type of the data stream, the access point may determine, based on the correspondence, the service requirement of the service to which the data stream belongs.

TABLE 1

| Service type | Service requirement |
|---|---|
| Firs-type service | Low latency (not higher than a first latency |
| | threshold) |
| Download service | Low packet loss rate |
| N^{th}-type service | High throughput |
| . . . | . . . |

It should be understood that, Table 1 shows only some possible correspondences between service types and service requirements by using examples. It should not be understood that the correspondence between the service type and the service requirement of the service is limited to only those shown in Table 1, and a service type and a service requirement are not limited to those shown in Table 1. For example, based on a requirement of an actual service, the correspondence between the service type and the service requirement may be alternatively expressed as a correspondence between a service of a type and a transmission latency and a throughput, a correspondence between a service of a type and a throughput and a packet loss rate, a correspondence between a service of a type and a transmission latency and a packet loss rate, or a correspondence between a service of a type and a transmission latency, a throughput, and a packet loss rate.

In addition, different types of services may have a same service requirement for a transmission latency, a throughput, or a packet loss rate. Different requirements may be proposed for values of transmission latencies (or throughputs or packet loss rates) of a plurality of types of services that have transmission latency (or throughput or packet loss rate) requirements. For example, both a K^{th}-type service and an L^{th}-type service require low latencies, but a transmission latency required by the K^{th}-type service is not higher than 30 milliseconds (ms), and the L^{th}-type service requires that a transmission latency should not be higher than 50 ms.

It should be understood that the “first-type service”, the “N^{th}-type service”, or the like in Table 1 may be replaced with a service type, such as an online game service, a download service, a video service, or a VR service.

For example, if the access point determines that the service to which the data stream belongs is the first-type service shown in Table 1, where it may be understood from Table 1 that, the first-type service has a relatively high transmission latency requirement (for example, a transmission latency required by the service type is not higher than 30 milliseconds (ms)), the access point may send the data stream by using a relatively low sending rate, so that a packet loss rate is reduced by reducing a sending rate, to reduce a transmission latency. In this example, the access point may determine a first transmission rate based on the service type of the data stream. The transmission rate corresponding to the first transmission rate is not greater than a first rate threshold. Subsequently, the data stream may be sent by using the transmission rate. For example, the first transmission rate is not greater than an average value of transmission rates at which the access point transmits data streams. When configuring the first rate threshold, the access point may configure a relatively small MCS rate (for example, an MCS rate less than or equal to an MCS rate average value).

For example, the first-type service may include a real-time online service such as multiplayer online battle arena (MOBA), or Player Unknown's Battlegrounds, or red packet grabbing, or another service that has a relatively high transmission latency requirement. Rates of data streams of these services are relatively small and usually do not exceed 2 megabits per second (Mbps). However, these services usually have relatively high data transmission latency requirements. When a data transmission latency is excessively high, service experience is severely affected. Therefore, for this type of service, a packet loss rate in a data transmission process may be reduced by reducing a sending rate, to reduce a transmission latency.

In another example, if the access point determines that the service to which the data stream belongs is a download service, for example, a hypertext transfer protocol (HTTP) download service, a download service of another protocol type, or another service that requires a relatively high throughput, the access point may reduce a packet loss rate in downlink transmission by using a relatively high transmission rate, so that packet retransmissions are reduced by reducing packet losses, to obtain stable high-rate download experience. In this example, the access point may determine a second transmission rate. The transmission rate corresponding to the second transmission rate is not less than a second rate threshold. For example, the second transmission rate is not less than the average value of transmission rates at which the access point transmits data streams. The second transmission rate may include a relatively large MCS rate. When configuring the second transmission rate, the access point may configure a relatively large MCS rate (for example, an MCS rate greater than or equal to the MCS rate average value).

In addition, the access point may alternatively store a correspondence between the service type and the transmission rate, so that after determining the service type of the service to which the data stream belongs, the access point can determine the transmission rate of the data stream based on the correspondence, without determining, based on the service type, the service requirement of the service to which the data stream belongs.

In implementation of S102, the access point may alternatively configure the transmission rate of the data stream based on the service type of the service to which the data stream belongs and information about traffic of the data stream (that is, a rate of the data stream). The traffic information of the data stream may be used to describe a traffic model of the data stream, to reflect a characteristic of the data stream. For example, the traffic information may reflect average traffic of the data stream, a traffic peak value, or whether burst traffic exists.

For example, after receiving the data stream, the access point may determine the traffic information of the data stream. When the access point determines that a relatively large traffic burst exists in the data stream, and the service to which the data stream belongs is a second-type service, the access point may configure the transmission rate of the data stream based on the average traffic of the data stream. The traffic burst means that one or more traffic peak values of the data stream each are not lower than n times of the average traffic of the data stream, and n is greater than 1, for example, n=1.5, 2, 3, . . . .

In this example, the access point may configure the transmission rate of the data stream to be not lower than x times of the average traffic of the data stream, where x is greater than 1. Therefore, the access point can provide a smooth air interface transmission rate for the service, thereby avoiding a packet loss caused by a transmission rate selection change due to air interface fluctuation, improving an anti-interference capability in downlink data transmission, and guaranteeing good experience of the service. X may be greater than n.

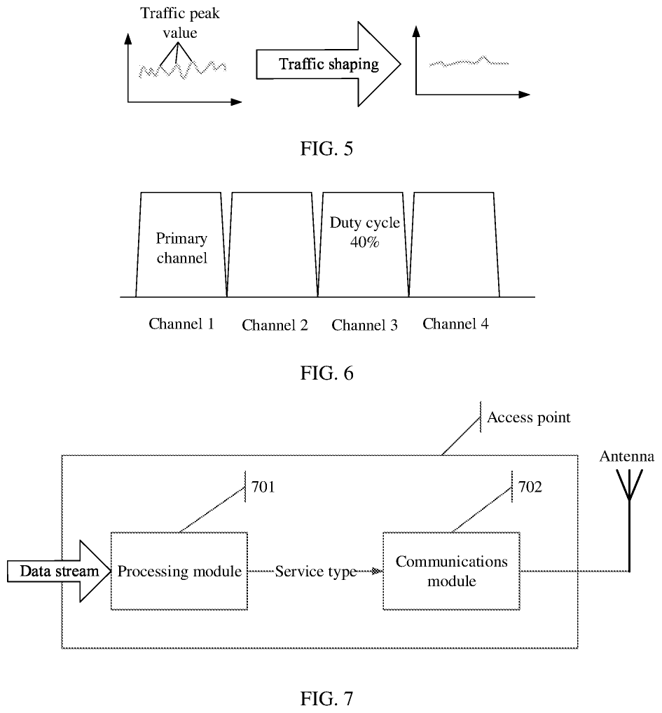

In addition, in this example, because the traffic burst exists in the data stream, and traffic fluctuation is relatively large, the access point may perform traffic shaping on the data stream, so that traffic fluctuation of the data stream is smoother, to reduce a traffic burst occurrence probability. Therefore, an anti-interference capability in downlink data transmission is further improved. As shown in FIG. 5, a data stream existing before traffic shaping includes a plurality of traffic peak values, and each traffic peak value is traffic at a peak of the data stream. Therefore, traffic fluctuation is relatively large. After the traffic shaping, the traffic fluctuation of the data stream is alleviated.

For example, for a service that has relatively large traffic and usually has a traffic burst in a data stream, such as a 4K high-definition video service, an interactive personality TV (IPTV) service, and/or a VR service, after receiving a data stream of this type of service, the access point may determine a third transmission rate based on average traffic of the data stream. The third transmission rate may be x times of the average traffic of the data stream, and x is greater than 1. Then, the access point may send, to the terminal device based on the third transmission rate, a data stream obtained after the traffic shaping. For a traffic shaping method, refer to a manner in the conventional technology. This is not limited.

In addition, the access point may alternatively store a correspondence between the service type, the traffic information of the data stream, and the transmission rate, so that after determining the service type of the service to which the data stream belongs and the traffic information, the access point may determine the transmission rate of the data stream based on the correspondence.

For example, the access point may further obtain a communication status parameter of the access point and a receive end, and configure, with reference to the service type of the service to which the data stream belongs and/or the traffic information of the data stream, the transmission rate used when the data stream is sent to the receive end. The receive end may include the terminal device that receives the data stream, for example, the terminal device shown in FIG. 2. In this method, a most appropriate communication parameter may be selected based on the service type and the traffic information of the downlink data stream and a communication status of the access point and the receive end, to implement flexible configuration. For example, the access point may obtain the communication status parameter in real time, and determine, based on the communication status parameter obtained in real time, a real-time configuration used to send the data stream to the receive end, to implement dynamic transmission rate configuration.

The communication status parameter may include a part or all of communication parameters such as an interference duty cycle, an air interface bit error rate, an air interface retransmission rate, a service concurrency parameter (used to indicate how many downlink service data streams are concurrent), or an air interface rate of the receive end.

The access point may determine, based on the service type of the data stream and the communication status parameter, a parameter such as an MCS rate configuration, an aggregation degree of an A-MSDU, an aggregation degree of an A-MPDU, resource application and allocation rules of the terminal device, a queue allocation rule of WMM, or a number of times configuration in a scheduling or retransmission policy that is based on an SSID and the terminal. The access point may determine an optimal transmission rate for data streams of a same type, to send the data streams.

In a possible example, the access point may configure the transmission rate of the data stream based on a correspondence between the service type, the communication status parameter and/or the transmission rate. After recognizing the service type of the data stream and/or obtaining the communication status parameter, the access point may determine, based on the correspondence, the service requirement of the service to which the data stream belongs. The correspondence between the service type, the communication status parameter, and/or the transmission rate may be shown in Table 2.

TABLE 2

| | | Transmission |
|---|---|---|
| Service type | Communication status parameter | rate |
| Firs-type | An interference duty cycle is lower than | Transmission |
| service | an interference duty cycle threshold | rate #1 |
| | An interference duty cycle is not lower | Transmission |
| | than the interference duty cycle threshold | rate #2 |
| HTTP | An air interface retransmission rate is | Transmission |
| download | lower than an air interface retransmission | rate #3 |
| service | rate threshold | |
| | An air interface retransmission rate is not | Transmission |
| | lower than the air interface retransmission | rate #4 |
| | rate threshold | |
| N^{th}-type | An air interface rate of a receive end is not | Transmission |
| service | lower than an air interface rate threshold | rate #4 |
| | An air interface rate of a receive end is | Transmission |
| | lower than the air interface rate threshold | rate #5 |
| . . . | . . . | |

When the access point recognizes that an interference duty cycle of an interference channel is greater than the interference duty cycle threshold, indicating that signal interference of the interference channel is relatively strong, the access point may allocate an idle channel to a data stream on the interference channel, to switch the data stream from the interference channel to the idle channel for sending, thereby improving an anti-interference capability in downlink data transmission. As shown in FIG. 6, when the access point recognizes that an interference duty cycle of a channel 3 reaches the interference duty cycle threshold, such as 40%, the access point may switch a to-be-transmitted data stream on the channel 3 to an idle channel (such as a channel 4) for transmission. For example, as shown in Table 2, when the transmission rate #1 is used, the access point transmits the data stream by using the interference channel. If the access point determines that the interference duty cycle of the interference channel is not lower than the interference duty cycle threshold, indicating that interference of the interference channel is relatively severe, the access point switches to an idle channel corresponding to the transmission rate #2, to transmit the data stream.

In another example, when the access point recognizes that a plurality of concurrent to-be-sent data streams exist, the access point may determine respective transmission priority parameters of the plurality of data streams based on respective transmission latency requirements of services to which the plurality of data streams belong. For example, to-be-transmitted data streams of the access point include a data stream A of a real-time online game service and another data stream B. To reduce a transmission latency of the data stream A, the access point may improve a forwarding priority of the data stream A. For example, the access point may configure a queue allocation rule of WMM to place the data stream A into a higher-priority WMM queue.

In another example, after obtaining the service type of the data stream and/or the communication status parameter, the access point may determine a transmission rate parameter, such as the MCS rate configuration, the aggregation degree of the A-MSDU, the aggregation degree of the A-MPDU, the resource application and allocation rules of the terminal device, the queue allocation rule of the WMM, or the number of times configuration in the scheduling or retransmission policy that is based on the SSID and the terminal, based on the service type of the data stream and the communication status parameter by using an artificial intelligence (artificial intelligence, AI) algorithm such as a neural network model.

In addition, based on a service transmission requirement, the access point may further determine the transmission rate parameter based on the service type of the data stream, the traffic information of the data stream, and/or the communication status parameter. For example, when the traffic information of the data stream meets a condition, the transmission rate parameter of the data stream is determined based on the correspondence shown in Table 2. The condition met by the traffic information of the data stream is, for example, that the average traffic of the data stream is not lower than a traffic threshold, or that a traffic burst exists (or does not exist) in the data stream.

When the access point is implemented, a possible structure of the access point may be shown in FIG. 7. It may be understood from FIG. 7 that, the access point may include a processing module 701 and a communications module 702. The processing module 701 may include a processor, for example, may be implemented by using an architecture of a CPU and/or an NPU. The processing module 701 may be configured to implement functions, such as data stream feature extraction, of the access point. The communications module 702 may be implemented by a scheduling module, a modem, or the like. The communications module 702 may be configured to perform communication configuration and send/receive a radio frequency signal by using an antenna. The processor may also be referred to as a system on chip (SOC). The communications module 702 may be referred to as a WIFI module. For example, the processing module may be implemented by a processing circuit such as a processing chip or a programmable logic controller (PLC). The communications module may be implemented by an interface circuit such as a PLC, or another medium.

The processing module 701 may determine a service type of a data stream, and the processing module 701 indicates the service type of the data stream to the communications module 702, so that the communications module 702 configures a transmission rate of the data stream based on the service type of the data stream, and sends the data stream, to meet a data transmission requirement of a service to which the data stream belongs.

In a possible example, when the service type is used to indicate that the service to which the data stream belongs is a first-type service, the communications module 702 may configure the transmission rate of the data stream as a first transmission rate. The first transmission rate is not greater than a first rate threshold. A transmission latency required by the first-type service is not higher than a latency threshold.

In another possible example, when the service type is used to indicate that the service to which the data stream belongs is an HTTP download service, the communications module 702 may configure the transmission rate of the data stream as a second transmission rate. The second transmission rate is not less than a second rate threshold.

In addition, the processing module 701 may obtain traffic information of the data stream, and the processing module 701 sends the traffic information of the data stream to the communications module 702, so that the communications module 702 configures the transmission rate of the data stream based on the service type and the traffic information of the data stream.

When the service type is used to indicate that the service to which the data stream belongs is a second-type service, and the traffic information is used to indicate that a traffic peak value of the data stream is not lower than n times of average traffic of the data stream, the communications module 702 may configure the transmission rate of the data stream to be not less than x times of the average traffic of the data stream, where x is greater than 1. A packet loss rate required by the second-type service is not higher than a packet loss rate threshold, and n is greater than 1. For example, x is greater than n.

In this example, the processing module 701 may further perform traffic shaping on the data stream.

In addition, the communications module 702 may obtain a communication status parameter of the access point and a receive end of the data stream, so that the processing module 701 or the communications module 702 configures the transmission rate of the data stream based on the service type of the service to which the data stream belongs, the traffic information of the data stream, and the communication status parameter.

The communications module 702 may alternatively determine a transmission rate parameter of the data stream according to the method, and the communications module 702 sends the data stream based on the parameter.

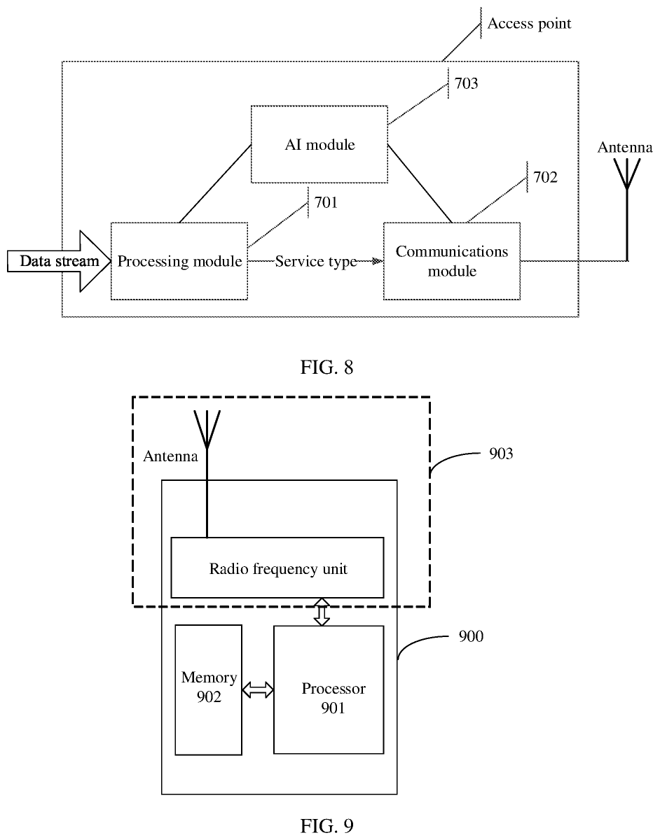

For example, as shown in FIG. 8, the communications apparatus may further include an AI module 703, configured to: when the downlink data stream needs to be sent, determine, by using an AI algorithm such as a neural network, the transmission rate parameter of the data stream based on the communication status parameter obtained by the communications module 702 and the service type of the service to which the data stream belongs and/or the traffic information of the data stream that are/is obtained by the processing module 701, and send the transmission rate parameter of the data stream to the communications module 702, so that the communications module 702 configures the transmission rate of the data stream. For example, the communications module may obtain the communication status parameter in real time, and send the communication status parameter obtained in real time to the AI module, so that the AI module determines, based on the communication status parameter obtained in real time, a real-time configuration used to send the data stream to the receive end, to implement dynamic transmission rate configuration.

In addition, the communications apparatus may alternatively include a structure shown in FIG. 9. As shown in FIG. 9, a communications apparatus 900 may include a processor 901, a memory 902, and a transceiver 903.

The processor 901 may be configured to: process a communication protocol and communication data, control a second terminal apparatus, execute a software program, process data of the software program, and the like. The memory 902 may be configured to store the program and data, and the processor 901 may perform, based on the program, the method performed by the second terminal apparatus in the embodiments.

The transceiver 903 may include a radio frequency unit and an antenna. The radio frequency unit may be configured to: perform conversion between a baseband signal and a radio frequency signal and process the radio frequency signal. The antenna may be configured to send and receive a radio frequency signal in a form of an electromagnetic wave. In addition, only the radio frequency unit may be considered as the transceiver 903. In this case, the communications apparatus 900 may include the processor 901, the memory 902, the transceiver 903, and the antenna.

It should be understood that the communications module 702 may have a structure shown in the transceiver 903, that is, the communications module 702 includes the radio frequency unit and the antenna. Alternatively, the communications module 702 may include the foregoing radio frequency unit. The foregoing processing module 701 and/or the AI module 703 may include the processor 901 or include the processor 901 and the memory 902.

When performing the method shown in the embodiments, the transceiver 903 may be configured to perform the steps performed by the communications module 702. The processor 901 invokes the program stored in the memory 902, to perform the foregoing steps performed by the processing module 701 and/or the AI module 703.

The processor 901 may determine a service type of a data stream, and the processor 901 indicates the service type of the data stream to the transceiver 903, so that the transceiver 903 configures a transmission rate of the data stream based on the service type of the data stream, and sends the data stream, to meet a data transmission requirement of a service to which the data stream belongs.

In a possible example, when the service type is used to indicate that the service to which the data stream belongs is a first-type service, the transceiver 903 may configure the transmission rate of the data stream as a first transmission rate. The first transmission rate is not greater than a first rate threshold. A transmission latency required by the first-type service is not higher than a latency threshold.

In another possible example, when the service type is used to indicate that the service to which the data stream belongs is an HTTP download service, the transceiver 903 may configure the transmission rate of the data stream as a second transmission rate. The second transmission rate is not less than a second rate threshold.

In addition, the processor 901 may obtain traffic information of the data stream, and the processor 901 sends the traffic information of the data stream to the transceiver 903, so that the transceiver 903 configures the transmission rate of the data stream based on the service type and the traffic information of the data stream.

When the service type is used to indicate that the service to which the data stream belongs is a second-type service, and the traffic information is used to indicate that a traffic peak value of the data stream is not lower than n times of average traffic of the data stream, the transceiver 903 may configure the transmission rate of the data stream to be not less than x times of the average traffic of the data stream, where x is greater than 1. A packet loss rate required by the second-type service is not higher than a packet loss rate threshold, and n is greater than 1. For example, x is greater than n.

In this example, the processor 901 may further perform traffic shaping on the data stream.

In addition, the transceiver 903 may obtain a communication status parameter of the access point and a receive end of the data stream, so that the processor 901 or the transceiver 903 configures the transmission rate of the data stream based on the service type of the service to which the data stream belongs, the traffic information of the data stream, and the communication status parameter.

The transceiver 903 may alternatively determine a transmission rate parameter of the data stream according to the method and the transceiver 903 sends the data stream based on the parameter.

It should be understood that the communications apparatus may alternatively include a chip. For example, the chip includes the processor 901. In addition, the chip may be further coupled to any one or more components in the memory 902 and/or the transceiver 903, or the chip may further constitute a chip system with the memory 902 and/or the transceiver 903.

Based on a same concept as that of the foregoing method embodiments, an embodiment further provides a computer-readable storage medium. The computer-readable storage medium stores a computer program. When the program is executed by a processor, the computer is enabled to perform the method performed by the access node in any one of the foregoing method embodiments or the possible implementations of the method embodiments.

Based on a same concept as the foregoing method embodiments, a computer program product may be invoked and executed by a computer to implement the method performed by the access node in any one of the foregoing method embodiments or the possible implementations of the method embodiments.

Based on a same concept as that of the foregoing method embodiments, a chip or a chip system may include a processor. The chip may further include a memory (or a storage module) and/or a transceiver (or a communications module), or the chip is coupled to a memory (or a storage module) and/or a transceiver (or a communications module). The transceiver (or the communications module) may be configured to support the chip in wired and/or wireless communication, and the memory (or the storage module) may be configured to store a program. The processor invokes the program to implement the method performed by the access node in any one of the foregoing method embodiments or the possible implementations of the method embodiments. The chip system may include the chip, or may include the chip and another discrete component, such as a memory (or a storage module) and/or a transceiver (or a communications module).

Based on a same concept as that of the foregoing method embodiments, a communications system may include the foregoing access point. The communications system may be configured to implement the method in any one of the foregoing method embodiments and possible implementations of the method embodiments. For example, the communications system has a structure shown in FIG. 1 or FIG. 2.

The embodiments are described with reference to the flowcharts and/or block diagrams of the method, the apparatus, and the computer program product according to the embodiments. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or the processor of the another programmable data processing device generate an apparatus for implementing a function in one or more processes in the flowcharts and/or in one or more blocks in the block diagrams.

These computer program instructions may alternatively be stored in a computer-readable memory that can instruct the computer or another programmable data processing device to work in a manner, so that the instructions stored in the computer-readable memory generate an artifact that includes an instruction apparatus. The instruction apparatus implements a function in one or more processes in the flowcharts and/or in one or more blocks in the block diagrams.

These computer program instructions may alternatively be loaded onto the computer or the other programmable data processing device, so that a series of operations and steps are performed on the computer or the another programmable device, to generate computer-implemented processing. Therefore, the instructions executed on the computer or the other programmable device provide steps for implementing a function in one or more processes in the flowcharts and/or in one or more blocks in the block diagrams.

What is claimed is:

1. A transmission rate configuration method, comprising:
determining, by an access point, a service type of a service to which a data stream belongs; and
configuring, by the access point, a transmission rate of the data stream based on the service type and traffic information of the data stream.

2. The transmission rate configuration method according to claim 1, wherein the service type is used to indicate that the service to which the data stream belongs is a second-type service and a packet loss rate required by the second-type service is not higher than a packet loss rate threshold; and the traffic information is used to indicate that a traffic peak value of the data stream is not lower than n times of average traffic of the data stream, and n is greater than 1; and
the configuring, by the access point, of the transmission rate of the data stream based on the service type and traffic information of the data stream comprises:
configuring, by the access point based on the service type and the traffic information of the data stream, the transmission rate of the data stream to be not less than x times of the average traffic of the data stream, wherein x is greater than 1.

3. The transmission rate configuration method according to claim 2, further comprising:
performing, by the access point, traffic shaping on the data stream.

4. The transmission rate configuration method according to claim 1, further comprising:
obtaining, by the access point, a communication status parameter of the access point and a receiver, wherein the receiver is configured to receive the data stream;
configuring, by the access point, the transmission rate of the data stream based on the service type and the communication status parameter; or
configuring, by the access point, the transmission rate of the data stream based on the service type, a traffic model of the data stream, and the communication status parameter.

5. The transmission rate configuration method according to claim 4, wherein the communication status parameter comprises at least one of the following parameters:
an air interface bit error rate;
an air interface retransmission rate; or
an air interface rate of the receiver.

6. The transmission rate configuration method according to claim 1, further comprising:
determining, by the access point, a transmission rate parameter of the data stream based on the service type, wherein
the transmission rate parameter of the data stream comprises at least one of the following parameters:
a modulation and coding scheme (MCS) rate configuration;
an aggregation degree of an aggregate media access control service data unit (A-MSDU);
an aggregation degree of an aggregate media access control protocol data unit (A-MPDU); or
a queue allocation rule of Wi-Fi multimedia (WMM).

7. A communications apparatus, comprising:
a processor;
a transceiver; and
a memory, wherein the memory stores a plurality of processor-executable instructions that, when executed by the processor, configure the processor and the receiver to perform operations comprising:
determining a service type of a service to which a data stream belongs; and
configuring a transmission rate of the data stream based on the service type and traffic information of the data stream.

8. The communications apparatus according to claim 7, wherein the service type is used to indicate that the service to which the data stream belongs is a second-type service and a packet loss rate required by the second-type service is not higher than a packet loss rate threshold; the traffic information is used to indicate that a traffic peak value of the data stream is not lower than n times of average traffic of the data stream, and n is greater than 1; and
wherein the operations further comprise:
configuring, based on the service type and the traffic information of the data stream, the transmission rate of the data stream to be not less than x times of the average traffic of the data stream, wherein x is greater than 1.

9. The communications apparatus according to claim 8, wherein the operations further comprise:
performing traffic shaping on the data stream.

10. The communications apparatus according to claim 7, wherein the operations further comprise:
obtaining a communication status parameter of the communications apparatus and a receive end, wherein the receive end is configured to receive the data stream; and
configuring the transmission rate of the data stream based on the service type and the communication status parameter; or
configuring the transmission rate of the data stream based on the service type, a traffic model of the data stream, and the communication status parameter.

11. The communications apparatus according to claim 10, wherein the communication status parameter comprises at least one of the following parameters:
an air interface bit error rate;
an air interface retransmission rate; or
an air interface rate of the receiver.

12. The communications apparatus according to claim 7, wherein the operations further comprise:
determining a transmission rate parameter of the data stream based on the service type, wherein
the transmission rate parameter of the data stream comprises at least one of of the following parameters:
a modulation and coding scheme (MCS) rate configuration;
an aggregation degree of an aggregate media access control service data unit (A-MSDU);
an aggregation degree of an aggregate media access control protocol data unit (A-MPDU); or
a queue allocation rule of Wi-Fi multimedia (WMM).
